(19) United States
(12) Patent Application Publication
(10) Pub. No.: US 2005/0049870 A1
(43) Pub. Date: Mar. 3, 2005

(54) Open vocabulary speech recognition

(76) Inventors: Yaxin Zhang, Hurstville (AU); Xin He, Shanghai (CN); Xiao-Lin Ren, Shanghai (CN); Fang Sun, Shanghai (CN)

Correspondence Address: MOTOROLA INC, 600 NORTH US HIGHWAY 45, ROOM AS437, LIBERTYVILLE, IL, 60048-5343, US

(21) Appl. No.: 10/925,601

(22) Filed: Aug. 24, 2004

(30) Foreign Application Priority Data
Aug. 29, 2003 (CN) 03156092.X

(51) Int. Cl. G10L 15/00

(52) U.S. Cl. 704/254

(57) ABSTRACT

There is described a method 300 for open vocabulary speech recognition performed by an electronic device (100). The method (300) includes receiving an utterance waveform (320) and Processing the waveform (350) to provide feature vectors representing the waveform. Then a step of comparing (360) is effected, the comparing compares the feature vectors with concatenated isolated word acoustic models from a concatenated isolated word acoustic model list to select a suitable concatenated isolated word acoustic model. Then a providing a response step (370) provides a response depending on the suitable concatenated isolated word acoustic model. The response typically is a control signal for activating a function of the device (100).

### FIELD OF THE INVENTION

This invention relates to open vocabulary speech recognition. The invention is particularly useful for, but not necessarily limited to, open vocabulary speech recognition processed on a portable electronic device having limited memory and computational capacity.

### BACKGROUND OF THE INVENTION

A large vocabulary speech recognition system recognises many received uttered words. In contrast, a limited vocabulary speech recognition system is limited to a relatively small number of words that can be uttered and recognized. Applications for limited vocabulary speech recognition systems include recognition of a small number of commands or names.

Large vocabulary speech recognition systems are being deployed in ever increasing numbers and are being used in a variety of applications. Such speech recognition systems need to be able to recognise received uttered words in a responsive manner without a significant delay before providing an appropriate response.

Large vocabulary Speech recognition systems typically use correlation techniques to determine likelihood scores between uttered words (an input speech signal) and characterizations of words in acoustic space. These characterizations can be created from acoustic models that require training data from one or more speakers and are therefore referred to as large vocabulary speaker independent speech recognition systems.

For a speaker independent large vocabulary speech recognition system, a large number of speech models is required in order to sufficiently characterise, in acoustic space, the variations in the acoustic properties found in an uttered input speech signal. For example, the acoustic properties of the phone /a/ will be different in the words “had” and “ban”, even if spoken by the same speaker. Hence, phone units, known as context dependent phones, are needed to model the different sound of the same phone found in different words.

A speaker independent large vocabulary speech recognition system typically spends an undesirable large portion of time finding matching scores, in the art known as the likelihood scores, between an input speech signal and each of the acoustic models used by the system. Each of the acoustic models is typically described by a multiple Gaussian Probability Density Function (PDF), with each Gaussian described by a mean vector and a covariance matrix. In order to find a likelihood score between the input speech signal and a given model, the input has to be matched against each Gaussian. The final likelihood score is then given as the weighed sum of the scores from each Gaussian member of the model. The number of Gaussians in each model is typically of the order of 6 to 64.

When considering closed vocabulary speech recognition systems and methods, a pre-defined fixed vocabulary list is employed. In use, this fixed vocabulary list may be large but may not be exhaustive and therefore, for instance, a person's family name and place names will not be included. In contrast, open vocabulary speech recognition systems and methods have a variable vocabulary list to which new words and phrases may be added by a user or otherwise. However, current open vocabulary speech recognition systems and methods require relatively high computational overheads that may not be acceptable for portable electronic devices such as Personal Digital Assistants, Laptop Computers, radio-telephones and other portable communication devices.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for open vocabulary speech recognition performed by an electronic device, the method comprising:
receiving an utterance waveform;
processing the waveform to provide feature vectors representing the waveform;
comparing the feature vectors with concatenated isolated word acoustic models from a concatenated isolated word acoustic model list to select a suitable concatenated isolated word acoustic model; and
providing a response depending on the suitable concatenated isolated word acoustic model.

Suitably, the concatenated isolated word acoustic model list is created from the steps of:
obtaining text from a vocabulary store;
converting the text into phonemes; and
concatenating phoneme models, corresponding to the phonemes, into concatenated isolated word models forming the concatenated isolated word acoustic model list.

Suitably, the list is created by storing the concatenated isolated word models in memory. Alternatively, the list is created by indexing selected ones of the models in phoneme model store.

Preferably, the acoustic model list is variable in size. Suitably, the acoustic model list created prior to operation of the step of receiving.

Suitably, the vocabulary is an open vocabulary. Preferably, the vocabulary may include text incrementally input. The text may suitably be incrementally input to the vocabulary by a user of the electronic device.

Suitably, the phoneme model store comprises Hidden Markov Models.

Preferably the response includes a control signal for activating a function of the device.

Alternatively, according to another aspect of the invention there is provided an electronic device for open vocabulary speech recognition. The device may suitably effect any or all of the above steps.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of an electronic device in accordance with the present invention;

FIG. 2 is a flow diagram illustrating a method for creating a concatenated isolated word acoustic model list used by the device of FIG. 1 in accordance with the present invention;

FIG. 3 is a diagram illustrating a method for open vocabulary speech recognition implemented on the device of FIG. 1 in accordance with the present invention;

FIG. 4 is a state diagram illustrating a phoneme acoustic model stored in a fixed phoneme store of the device of FIG. 1; and

FIG. 5 is a state diagram illustrating a concatenated isolated word acoustic model state diagram.

### DETAILED DESCRIPTION OF THE PREFERRED EMBODIMENT OF THE INVENTION

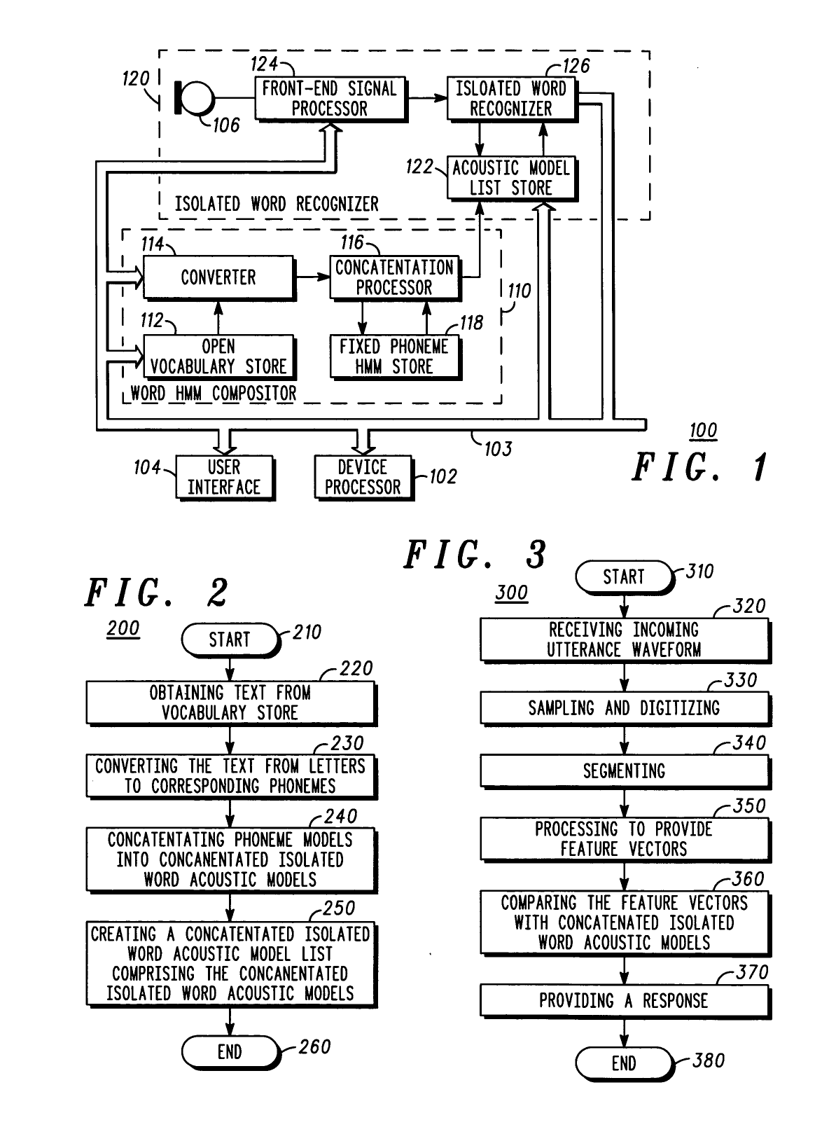

Referring to FIG. 1 there is illustrated an electronic device 100 comprising a device processor 102 operatively coupled by a bus 103 to a user interface 104 that is typically a touch screen or alternatively a display screen and keypad. The user interface 104 is operatively coupled by the bus 103 to an open vocabulary store 112 of a Word Hidden Markov Model compositor 110. The Word Hidden Markov Model compositor 110 also includes a converter 114 with an input operatively coupled to an output of the open vocabulary store 112. An output of the converter 114 is operatively coupled to an input of a concatenation processor 116. The concatenation processor 116 is operatively coupled to a fixed phoneme Hidden Markov Model store 118 and one output of the concatenation processor 116 is operatively coupled to an acoustic model list store 122 forming part of an isolated word recognizer 120.

The isolated word recognizer 120 also includes a microphone 106 operatively coupled to a front-end signal processor 124 with an output operatively coupled to an input of an isolated word recognizer 126. The isolated word recognizer 126 is operatively coupled to the acoustic model list store 122 and an output of the isolated word recognizer 126 is also operatively coupled, by bus 103, to the device processor 102. The bus 103 also couples the device processor 102 to the front-end signal processor 124 and converter 114. Preferably, in this embodiment the store 122 is also coupled to the device processor 102 by the bus 103.

Referring to FIG. 2 there is a flow diagram illustrating a method 200 for creating a concatenated isolated word acoustic model list used by the device 100. The method is invoked, thereby creating the concatenated isolated word model list, at a start step 210 by power up of the device 100 or when a user inputs a new word or phrase into the open vocabulary store 112 via the user interface 104. After start step 210 the method 200 performs a step 220 of obtaining text from the open vocabulary store 112. Then a step 230, performed by converter 114, provides for converting the text from letters to corresponding phonemes. The concatenation processor 118 then effects a step 240 for concatenating phoneme models, corresponding to the phonemes, into concatenated isolated word acoustic models. For instance, if one of the words in the open vocabulary store is “but” then this word is converted at step 230 in three phonemes /b/, /ah/ and /t/.

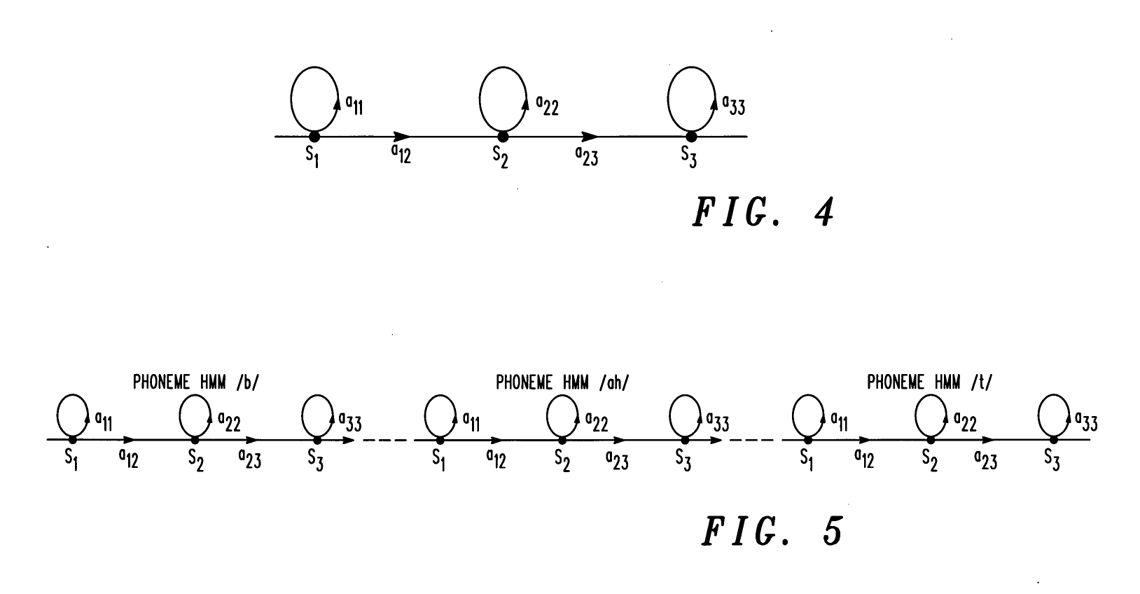

Referring to FIG. 4,there is state diagram, of a Hidden Markov Model (HMM), illustrating a phoneme model (phoneme acoustic model) stored in a fixed phoneme store 118. The state diagram is for one possible phoneme /b/ that is modeled by three states S₁, S₂, S₃ . Associated with each state are transition probabilities, where a₁₁ and a₁₁ are transition probabilities for state S₁, a₂₁ and a₂₂ are transition probabilities for state S₂ and a₃₁ and a₃₂ are transition probabilities for state S₃ Thus as will be apparent to a person skilled in the art, the state diagram is a context dependent tri-phone with each state S₁, S₂, S₃ having a Gaussian mixture typically between 6-64 components. Also the middle state S₂ is regarded as the stable state of a phoneme HMM while the other two states are transition states describing the co-articulation between two phonemes.

Referring back to FIG. 2, the step 240 for concatenating provided at step 240 results in the concatenated isolated word acoustic model state diagram for the phonemes /b/, /ah/ and /t/ as illustrated in FIG. 5. As shown each state diagram or HMM is concatenated by direct sequential coupling. The method 200 then provides at a step 250 for creating a concatenated isolated word acoustic model list comprising the concatenated isolated word acoustic models. This list is typically stored in memory that is preferably the acoustic model list store 122. Alternatively, the list is created by indexing selected ones of the models in the fixed phoneme Hidden Markov Model store 118, thus the concatenated isolated word acoustic models are concatenated by an indexing Hidden Markov Models in store 118. The method 200 then terminates at an end step 260 and is invoked again on a subsequent device power up of device 100 or when a user inputs a new word or phrase into the open vocabulary store 112.

Referring to FIG. 3 there is illustrated a method 300 for open vocabulary speech recognition performed by an electronic device 100. After a start step 310, invoked by a user typically providing an actuation signal at the interface 104, the method 300 performs a step 320 for receiving an utterance waveform input at microphone 106. The front-end signal processor 124 then performs sampling and digitizing the utterance waveform at step 330, then segmenting at a step 340 before processing to provide feature vectors representing the waveform at a step 350. It should be noted that steps 320 to 350 are well known in the art and therefore do not require a detailed explanation.

The method 300 then, at a step 360, provides for comparing the feature vectors with concatenated isolated word acoustic models from the concatenated isolated word acoustic model list to select a suitable concatenated isolated word acoustic model. The comparing is effected by the isolated word recognizer 126 searching the acoustic model list of stored in the acoustic model store 122. Thereafter, a providing step 370 performed by recognizer 126 provides a response (recognition result signal) depending on the suitable concatenated isolated word acoustic model selected at step 360.

Advantageously, the present invention allows for open vocabulary speech recognition to effect commands for device 100. These commands are typically input by user utterances detected by the microphone 106 or other input methods such as speech received remotely by radio or networked communication links. The method 300 effectively receives an utterance at step 320 and the response at step 370 includes providing a control signal for controlling the device 100 or activating a function of the device 100. Such a function can be traversing a menu or selecting a phone number associated with a name corresponding to a received utterance of step 320.

The invention allows for open vocabulary speech recognition in which the open vocabulary store 112 may include text incrementally input to the vocabulary store 112 by a user of the electronic device 100. Also, the concatenated isolated word acoustic model list is created by power up of the device 100 or when a user inputs a new word or phrase into the open vocabulary store 112 via the user interface 104. Hence, the concatenated isolated word acoustic model list is activated prior to the operation of the receiving step 320. Accordingly, the invention alleviates some of the relatively high computational run time overheads associated with prior art open vocabulary speech recognition.

The detailed description provides a preferred exemplary embodiment only, and is not intended to limit the scope, applicability, or configuration of the invention. Rather, the detailed description of the preferred exemplary embodiment provides those skilled in the art with an enabling description for implementing preferred exemplary embodiment of the invention. It should be understood that various changes may be made in the function and arrangement of elements without departing from the spirit and scope of the invention as set forth in the appended claims.

1. A method for open vocabulary speech recognition performed by an electronic device, the method comprising:
receiving an utterance waveform;
processing the waveform to provide feature vectors representing the waveform;
comparing the feature vectors with concatenated isolated word acoustic models from a concatenated isolated word acoustic model list to select a suitable concatenated isolated word acoustic model; and
providing a response depending on the suitable concatenated isolated word acoustic model.

2. A method, as claimed in claim 1, wherein the concatenated isolated word acoustic model list is created from the steps of:
obtaining text from a vocabulary store;
converting the text into phonemes; and
concatenating phonemes, corresponding to the phonemes, into concatenated isolated word models forming the concatenated isolated word acoustic model list.

3. A method, as claimed in claim 2, wherein the list is created by storing the concatenated isolated word models in memory.

4. A method, as claimed in claim 2, wherein the list is created by indexing selected ones of the models in phoneme model store.

5. A method, as claimed in claim 2, wherein the acoustic model list is variable in size. Suitably, the acoustic model list created prior to operation of the step of receiving.

6. A method, as claimed in claim 1, wherein, the vocabulary is an open vocabulary.

7. A method, as claimed in claim 2, wherein, the vocabulary is an open vocabulary.

8. A method, as claimed in claim 2, wherein the vocabulary includes text incrementally input.

9. A method, as claimed in claim 8, wherein the text is incrementally input to the vocabulary by a user of the electronic device.

10. A method, as claimed in claim 2, wherein the phoneme model store comprises Hidden Markov Models.

11. A method, as claimed in claim 2, wherein the response includes a control signal for activating a function of the device.
